(19) United States
(12) Patent Application Publication
(10) Pub. No.: US 2016/0379460 A1
(43) Pub. Date: Dec. 29, 2016

(54) ROAM FREE CHILD SECURITY

(71) Applicants: DERRICK BARKER, Pershore (GB); Bernie Ting Wai Chung, Aberdeen (CN); Stanley Chan Sui Hung, Aberdeen (CN); Yau Choi Tse, Dalang Town (CN)

(72) Inventors: DERRICK BARKER, Pershore (GB); Bernie Ting Wai Chung, Aberdeen (CN); Stanley Chan Sui Hung, Aberdeen (CN); Yau Choi Tse, Dalang Town (CN)

(21) Appl. No.: 14/726,663

(22) Filed: Jun. 1, 2015

Related U.S. Application Data
(63) Continuation of application No. 13/626,863, filed on Sep. 25, 2012, now abandoned.
Application No. 13/626,863 is a continuation-in-part of application No. PCT/GB11/00171, filed on Feb. 10, 2011.

(30) Foreign Application Priority Data
Feb. 13, 2010 (GB) 1002483.4

(51) Int. Cl. G08B 21/02

(52) U.S. Cl. CPC G08B 21/0208; G08B 21/0277

(57) ABSTRACT

The invention describes a child monitoring and early warning system, which monitors the child's position in the home. The system provides monitoring of a sleeping baby and in addition is able to detect/monitor a child's position and relay two way voice and video communication to warn the adult of the child's position.

This is a continuation in part application under 35 USC 120 of PCT/GB2011/000171, filed Feb. 10, 2011, the disclosure of which is incorporated herein by reference.

### FIELD OF INVENTION

This invention relates to child safety monitoring and early warning system which monitors the child's position in the home and garden. The system provides monitoring of a sleeping baby and, in addition, is able to detect/ monitor a child's position and relay two way voice and video communication to warn the adult of the child's position.

### BACKGROUND OF INVENTION

Baby safety systems have been in widespread use worldwide for many years.

There are current systems described as baby monitors, which provide remote monitoring of a child primarily in a static position, such as in a cot or cradle and provide information to the adult.

There are also tracking solutions primarily used when out and about and away from the home, to alert the parent that the child has strayed to far. Some systems use GPRS location finding.

### SUMMARY OF THE INVENTION

An object of the invention is to provide a child security system which unlike all pre-existing child monitor systems in that it is aimed at monitoring a toddler on the move within the home or similar residential situation, in addition to monitoring a child primarily in a static situation or single location such as a sleeping baby.

This is done using positional or location sensors, which interact with a portable device/unit fixed to the child. The device is able to transmit data and images to the hand held unit held by the adult.

A baby camera unit of the invention can also be combined with the camera base and communicate with the hand held unit to act as a conventional baby monitor system.

### BRIEF DESCRIPTION OF THE DRAWINGS

FIG. 1 shows the hand held unit;

FIG. 2 shows the location sensor;

FIG. 3 shows the camera base with the baby camera unit;

FIG. 4 shows the vest;

FIG. 5 shows a block diagram of the baby camera unit, showing its process and functions;

FIG. 6 shows a block diagram of the camera base, showing its process and functions;

FIG. 7 shows a block diagram of the hand held unit, showing its process and functions;

FIG. 8 shows a block diagram of the location sensor, showing its process and functions;

FIG. 9 shows the child near the dangerous area, the sensor detects the baby camera unit and emits an audible warning message or sound;

FIG. 10 shows the adult monitoring the child by the hand held unit;

FIG. 11 shows the camera base with the baby camera unit output lullabies to the baby for sleeping; and

FIG. 12 shows the adult monitoring the baby sleeping by using the hand held unit.

### DESCRIPTION OF THE PREFERRED EMBODIMENT

The child monitoring and early warning system comprises the following.

The camera base charging unit.

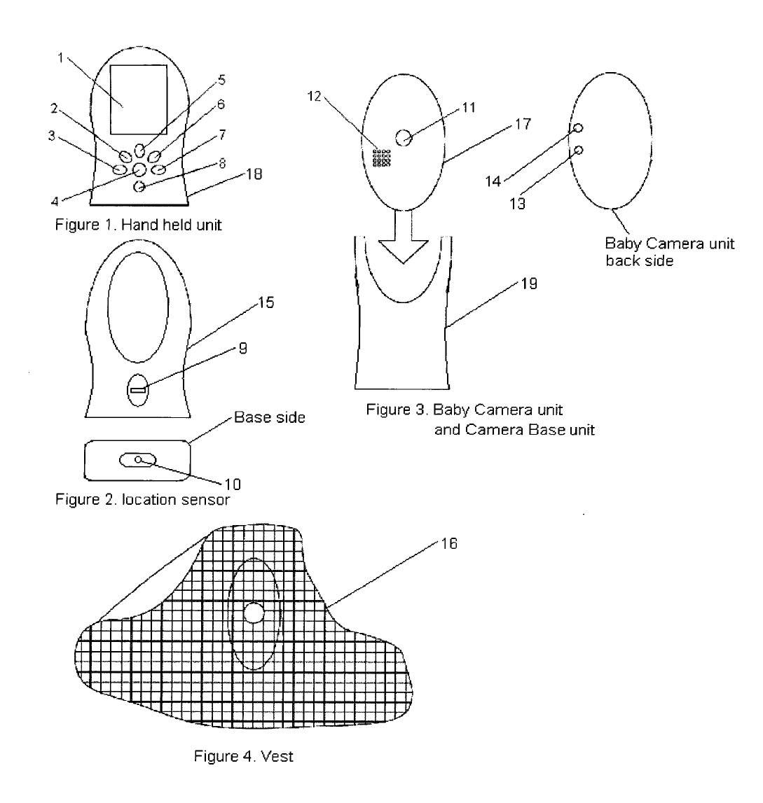

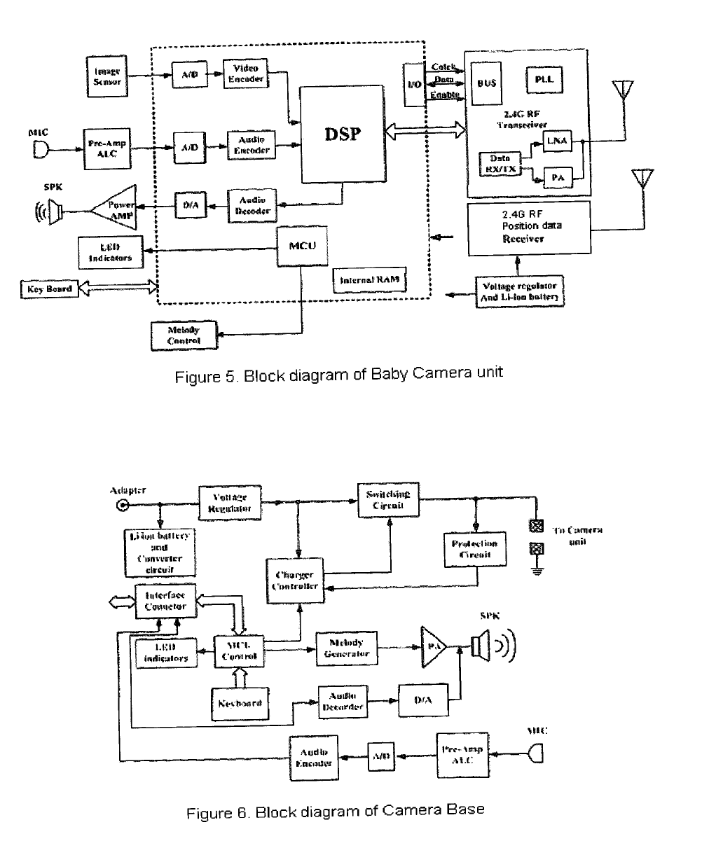

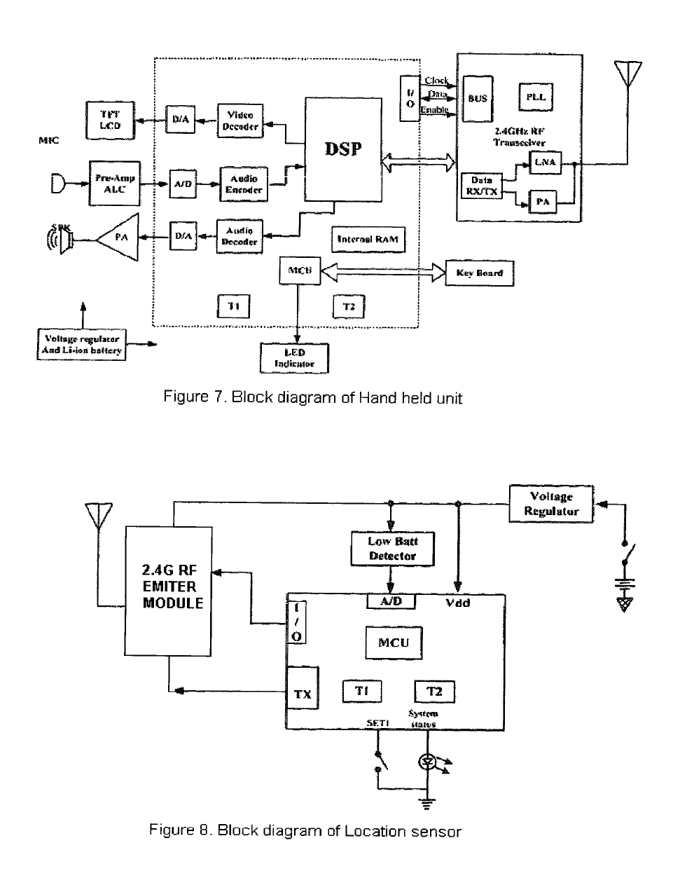

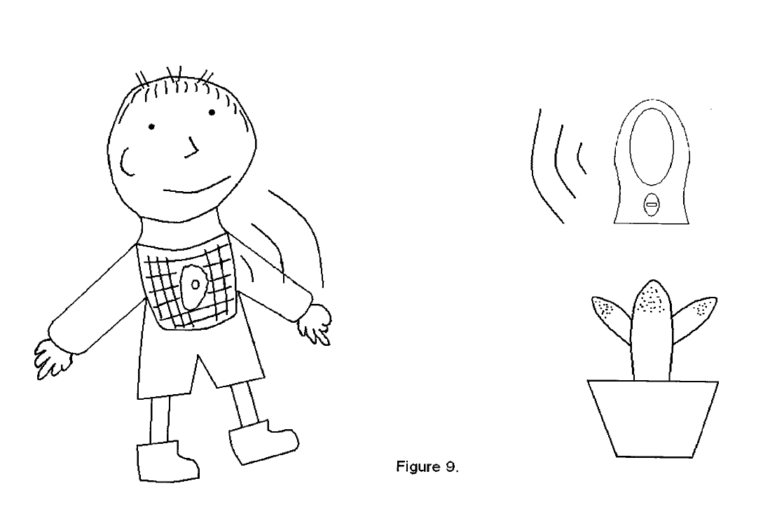

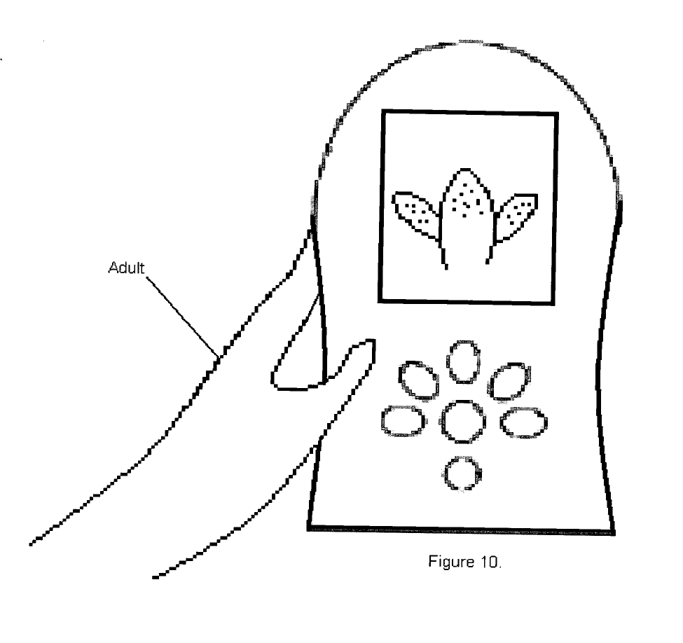

Hand held unit (FIG. 1) has a speaker, LCD video screen 1, microphone sender and receiver for two way voice and vision communication with the series of baby camera units and the camera base.

The baby camera unit invention can be secured to the child and combined with the camera base. The baby camera unit (FIG. 3) has a speaker 12, camera 11, microphone, receiver and sender for two way communications with the hand held unit (FIG. 1) and the location sensor. (FIG. 2)

Location sensor (FIG. 2) has a sender and receiver and communicates with the baby camera unit

The camera base charging unit is to accommodate the baby camera unit. The baby camera unit has a speaker, receiver and microphone, also a temperature measuring, night light and lullabies. (FIG. 3)

The system operations are such that the location sensors are placed around the home. The child wears the baby camera unit 17 with vest 16 (FIG. 4) which reacts with the location sensor 15 when within proximity. The camera emits an audible warning message or sound, which distracts and deters the child (FIG. 9). At the same time the camera sends a signal to the hand held unit 18, which tells the adult where the child is by way of visual display and audible indication. (FIG. 10)

In operation, the adult communicates with the baby camera unit to remotely activate the camera.

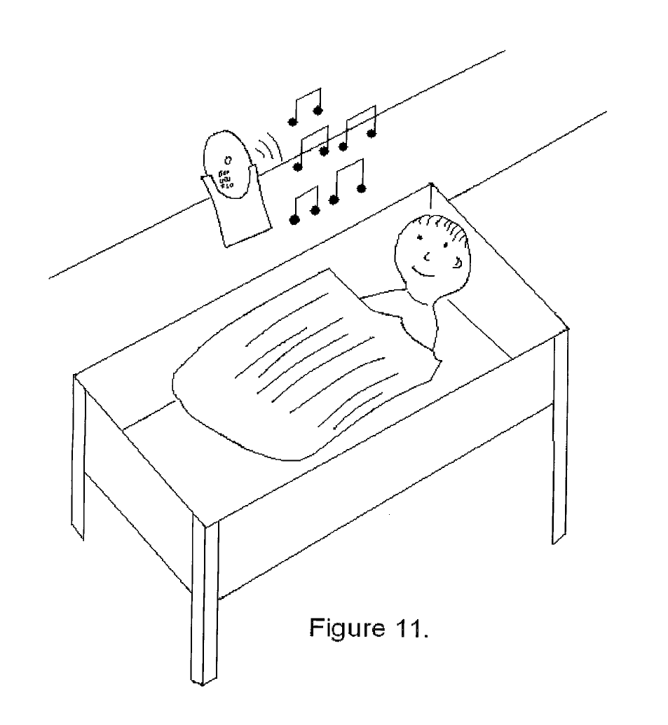

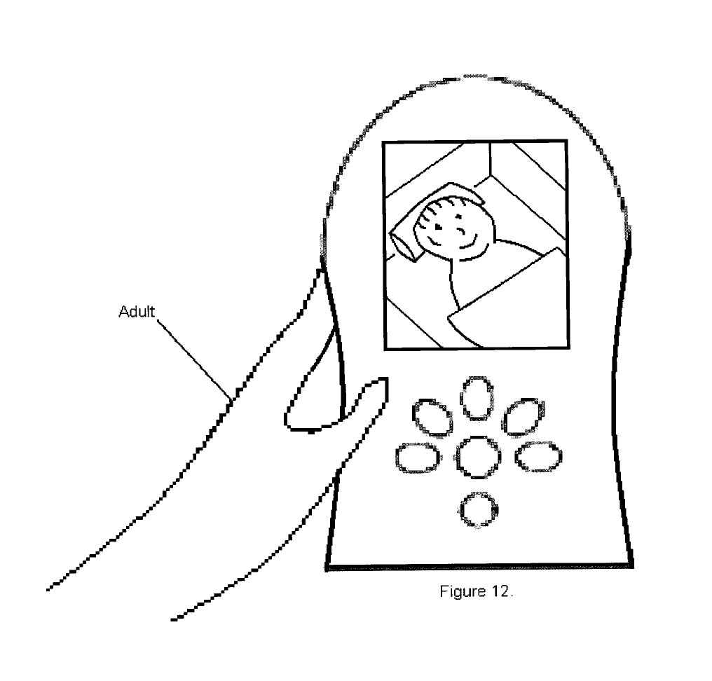

The baby camera unit 17 is mounted on the camera base 19 to act as a static and local monitor, operating in much the same way as existing baby monitors and, in this mode, can be recharged. When the baby is sleeping badly, the camera base with the baby camera unit output lullabies to the baby, (FIG. 11) and the adult monitors the baby by the hand held unit 21 (FIG. 12)

The monitoring system enables a multiple of Baby Camera unit to communicate with the hand held unit and location sensors.

The monitoring system include a camera as part of RF transceiver communicating with the hand held unit and baby camera unit carried by the child

### Function of Each Unit and Button

Hand Held Unit

1—LCD Display

2—power

3—Vol. decrease

4—Menu

5—Voice/Menu up

6—Channel

7—Vol. increase

8—Menu down

Location sensor

9—Sensitivity position (Hi, Mid, Low)

10—Power

Baby Camera unit

11—Camera

12—Speaker

13—Power

14—Binding

A thermal sensor is located in the baby unit to sense room temperature data, the data is sent to parent unit and shows the room temperature on a LCD fully automatically.

Light sensor is used to measure environment lighting, IR LED array on the camera base unit are disabled when environment light is still bright and IR LED array will be turned on to emit infra red beam when environment light is dim enough, so that the baby unit can be used to monitoring baby in dark room when it is on the camera base unit.

Five (5) individual IR LED are built inside the camera base unit. The IR LED turn on when environment light is dim and night vision function is performed with the baby unit is on the camera base unit

### Specification:

### Baby Camera Unit

Power Supply Circuit

1. Battery type: Li-ion rechargeable, 3.7V 1000 mAH (built in protection chip inside)

2. Battery voltage: 3.7V (2.5V˜4.6V)

3. Battery capacity: 1000 mAH (+/10%)

4. Standby current: 36 mA (+/−10%, only receiver circuit active)

5. Audio RF sending current: 120 mA (+/−10% at 4V BATT and 60% VOL, LCD off)

6. Video sending current: 110 mA (+/−10% at 4V BATT and 60% VOL, Audio off)

7. Total current: 230 MA (+/−10% at 4V BATT, Audio+Video)

8. Fast charging time: 3 hours for 85% charging (+/−15%)

9. Fully charging time: 6 hours (+/−15%)

10. Maximum (initial) charging current: 300 mA (+/−15%)

11. Saturated (ending) charging current: 1.3 mA (+/−15%)

Main RF Module Circuit

12. Transceiver frequency: 2.4 GHZ(ISM band)

13. Frequency hopping range: 2402˜2482 MHZ (even channels)

14. Channel size: IMHZ

15. TX/RX frequency stability: 3PPM (+/−1 PPM)

16. Transmission power: <20 dBm (100 mW)

17. Transmission distance: >200 M (open area with 1.5 M height)

18. TX modulation: GFSK

19. Transmission data rate: 3 Mbs

20. Receiver sensitivity: −90 dB (+/−2 dB)

Sub-RE Receiver Module for Motion Detection

21. Receiving frequency: 2.4 GHz (ISM band)

22. Frequency hopping range: 2403˜2483 MHz (odd channels)

23. Channel size: 1 MHz

24. Receiving frequency stability: 3 PPM (+/−1 PPM)

25. Receiver sensitivity: −90dB (+/−2 dB)

Camera Module

26. CMOS image sensor resolution: VGA 640*480,300 K pixels

27. Minimum illumination: <0.5LUX

28. Night vision: >2 m (built in 5PCS IR LED 850 nM)

29. Video frame rate: 30FPS for QVGA

Sound monitoring with 2-ways speech

30. Audio sampling rate: 16 KHz

31. Digitized bit: 8 bits

32. Frequency response: 300 Hz˜6 KHz

33. VOX Hi sensitivity: 50 dB (+/−5 dB) at Hi setting

34. VOX Lo sensitivity: 63 dB (+/−5dB) at Lo setting

35. Speaker: 8 ohm with 0.25 W

36. Microphone sensitivity: −54 dB (+/−2 dB)

Miscellaneous

37. Operation temperature: 0˜65

38. Humidity range: 15˜95%

39. Meet FCC and EMC regulation

40. ROHS compliance

41. Battery life:
Battery life for continuing standby: >25 hours
Battery life for continuing working: 5˜10 hours, depend on working mode

### Camera Base

DC Adaptor

1. Input voltage: AC 90V˜240V, 50 Hz˜60 Hz

2. Output voltage: DC 5V with 800 mA

3. Standby current plus charging: 36 mA˜300 mA (+/−15%) connected baby unit

4. IR LED (5PCS): 100 mA (+/−10%)

HAND HELD UNIT

Power Supply circuit

1. Battery type: Li-ion rechargeable, 3.7V 1000 mAH, (built in protection chip inside)

2. Battery voltage: 3.7V (2.5V˜4.6V)

3. Battery capacity: 1000 mAH (+/−10%)

4. Power off (quiescent current) :<23 uA

5. Standby current: 30 mA (+/−10%, only receiver circuit active)

6. Audio RF sending current: 120 mA (+/−10% at 4V BATT and 60% VOL, LCD off)

7. Video sending current: 110 mA (+/−10% at 4V BATT and 60% VOL, Audio off)

8. Total current: 230 mA (+/−10% at 4V BATT, Audio+video)

9. Fast charging time: 3 hours for 85% charging (+/−15%)

10. Fully charging time: 6 hours (+/−15%)

11. Maximum (initial) charging current: 300 mA (+/−15%)

12. Saturated (ending) charging current: 1.3 mA (+/−15%)

Main RF Module Circuit

13. Transceiver frequency: 2.4 GHz (ISM band)

14. Frequency hopping range: 2402˜2482 MHz (even channels)

15. Channel size: 1 MHZ

16. TX/RX frequency stability: 3 PPM (+/−1 PPM)

17. Transmission power: <20 dBm (100 mW)

18. Transmission distance: >200 m (open area with 1.5M height)

19. TX modulation: GFSK

20. Transmission data rate: 3 Mbs

21. Receiver sensitivity: −90dB (+/−2 dB)

LCD Module circuit

22. LCD Size: 2.4 inch

23. Video resolution: 320*240

24. Brightness adjustment: Set in system menu by 10 levels

25. Contrast adjustment: Set in system menu by 10 levels

26. Volume adjustment: Set in system menu by 10 levels

27. RSSI indication: Shown an icon on LCD for RF signal quality indication

Sound monitoring with 2-ways speech

28. Audio sampling rate: 16 KHz

29. Digitized bit: 8 bits

30. Frequency response: 300 Hz˜6 KHz

31. VOX Hi sensitivity: 50 dB (+/−5 dB) at Hi setting

32. VOX Lo sensitivity: 63 dB (+/−5 dB) at Lo setting

33. Speaker: 8 ohm with 0.25 W

34. Microphone sensitivity: −54 dB (+/−2 dB)

Miscellaneous

35. Operation temperature: 0˜65

36. Humidity range: 15˜95%

37. Meet FCC and EMC regulation

38. ROHS compliance

39. Battery life:
Battery life for continuing standby: >30 hours
Battery life for continuing working: 5˜10 hours, depend on working mode

Location Sensor

DC Power Supply Circuit

1. Battery type: Alkaline, AAA size, 2PCS with 1000 mAH

2. Operation Voltage: 3V (2.1V˜3.6V)

3. Low battery indication: 2.3V (+/−0.2V)

4. Current consumption:
Detection and transmission current at Lo setting: <0.26 mA (average value)
Detection and transmission current at Mi setting: <0.27 mA (average value)
Detection and transmission current at Hi setting: <0.28 mA (average value)

5. Battery life:
Battery life at Lo transmission: 160 days
Battery life at Mi transmission: 150 days
Battery life at Hi transmission: 140 days

RF Transmission Circuit Specification

6. Transceiver frequency: 2.4 GMHz (ISM band)

7. Frequency hopping range: 2403˜2483 MHz (odd channels)

8. Channel size: 1 MHz

9. TX frequency stability: 3 PPM (+/−1 ppm)

10. Transmission power: 0 dBm˜6 dBm (set by switch and adjust by MCU)

11. Transmission distance:
Short distance detection: 3M (1M˜7M) Alternative 0.5M-9M
Middle distance detection: 9M (3˜18M) Alternative 3M-16M
Far distance detection: >18M Alternative>16M

12. Detection response time: <2 s

13. Detection angle: 360 degree

Miscellaneous

14. Operation temperature: 0˜65

15. Humidity range: 15˜95%

16. Meet FCC and EMC standard

17. ROHS compliance

18. One Baby Camera unit can detect up to 3 pieces of location sensors.

This is preliminary product specification of RF Roam Free and it may be verified after Proceeded FEP process.

1) A child monitor system comprising:
a hand held unit which incorporates a microphone, speaker, LCD video screen, RF transmitter and receiver;
a base and charging station which incorporates a speaker, microphone and power supply,
a baby camera unit which incorporates a speaker, camera and microphone and receiver; and
at least one position/location sensors which incorporates a RF transmitter;
wherein all of which can be arranged so that the baby camera unit is attached to the child, the location sensors are positioned in various locations such that when the baby camera unit comes within range of the sensor it will activate the baby camera unit to initiate two way communication of voice and images with the hand held unit and that said hand held unit can remotely activate the baby camera unit or the camera base.

2) The system according to claim 1 wherein the baby camera unit incorporates two way sound and vision communication with the hand held unit.

3) The system according to claim 2 wherein the baby camera unit has transmitting and receiving communication with the location sensor via one of radio frequency, blue tooth and pyro-electric infrared.

4) The system according to claim 3 wherein the location sensor unit is adjustable in range and incorporates a vision camera.

5) The system according to claim 1 wherein the hand held unit communicates with the baby camera unit remotely while the portable responder is being used on the camera base or on the move with the child.

6) The system according to claim 1 including a multiple of said location sensors

7) The system according to claim 1 including a multiple of said baby camera units.

8) The system according to claim 7 a hand held unit able to transmit to and receive from sound and vision communication with a series of Baby Camera units.

9) The system according to claim 1 wherein the hand held unit remotely activates the baby camera unit.
